(19) United States
(12) Patent Application Publication
(10) Pub. No.: US 2026/0132671 A1
(43) Pub. Date: May 14, 2026

(54) Fenestrations with Interchangeable Inserts

(71) Applicants: Dion Der sarkissian, Passadena, CA (US); Arin Der sarkissian, Toluca Lake, CA (US)

(72) Inventors: Dion Der sarkissian, Passadena, CA (US); Arin Der sarkissian, Toluca Lake, CA (US)

(21) Appl. No.: 18/941,746

(22) Filed: Nov. 8, 2024

(51) Int. Cl. E06B 3/28

(52) U.S. Cl. CPC E06B 3/28

(57) ABSTRACT

A customizable fenestration includes a fenestration slab with an insert cavity for reception of one or more panels, and a hatch slab with a panel cavity for reception of one or more panels. The hatch slab is pivotably mounted on the fenestration slab to be rotatable between a first closed position and a second open position, with the panel cavity of the hatch slab aligning with the insert cavity of the fenestration slab when the hatch panel is in the closed position. In use, the insert cavity may receive an ornate design panel that permits an airflow through the fenestration slab and the panel cavity may receive a barrier panel that prevents an airflow through the hatch slab. The barrier panel may optionally be made of a translucent material or an opaque material.

### FIELD OF THE INVENTION

The present invention relates to fenestrations, including doors and windows, having a multi-panel construction that enables selective customization of an aesthetic appearance and selective control of airflow therethrough.

### BACKGROUND OF THE INVENTION

Fenestrations, including doors and windows, are a common element in the construction of modern buildings, traditionally serving as means of securing entryways to keep out unauthorized persons, protecting inhabitants from inclement weather and other external elements, and providing seclusion and privacy. In modern construction, fenestrations are commonly made to provide visual appeal and an aesthetic expression of the building. This has led to considerable variance, for example, in the construction of doors and windows from one building to another. It would thus be beneficial to have a highly customizable fenestration construction that enables the production of fenestrations with varying aesthetic expressions.

### SUMMARY OF THE INVENTION

A fenestration slab comprises a perimeter defining an outer boundary of the fenestration slab, with an insert cavity at an inner region of the fenestration slab, the insert cavity being configured to releasably hold one or more interchangeable panels; a hatch slab supported on the fenestration slab, the hatch slab having an outer perimeter and a panel cavity at an inner region of the hatch slab, the panel cavity being configured to hold one or more panels. The fenestration slab may be configured for use as a door slab, a window slab, or any other portal-type slab.

The hatch slab is pivotably supported on the fenestration slab for rotation between a first position and a second position, the first position being a closed position in which the outer perimeter of the hatch slab is positioned to correspond with a perimeter of the insert cavity in the fenestration slab such that the hatch slab serves to close an opening to the insert cavity of the fenestration slab, with the panel cavity of the hatch slab aligning with the insert cavity of the fenestration slab.

The hatch slab may be mounted at an inner side surface of the fenestration slab such that the perimeter of the hatch slab protrudes from the inner surface of the fenestration slab when in the closed position; or may be mounted at a surface within the insert cavity of the fenestration slab such that the perimeter of the hatch slab resides within the insert cavity of the fenestration slab when in the closed position. Weather sealing may be provided between the insert cavity and the hatch slab to hinder fluid flow from an outer side of the fenestration slab to an inner side of the fenestration slab through the insert cavity. The insert cavity may also have a drainage configuration that promotes drainage of collected fluid to the outer side of the fenestration slab. Methods constructing the fenestration slab may include securing the hatch slab to the fenestration slab, and securing weather sealing between the fenestration slab and the hatch slab.

The fenestration slab is configured for reception of a design panel releasably secured within the insert cavity of the fenestration slab, with a backing panel releasably secured within the panel cavity of the hatch slab. The design panel may be an ornate panel with openings that permit airflow therethrough, and the backing panel may be a barrier panel that prevents airflow through the panel cavity. The backing panel may be translucent to permit transmission of light or may be opaque to preclude transmission of light. A screen panel may be releasably secured in the insert cavity, at a position to reside between the design panel and the backing panel.

The drainage configuration may include weeping holes provided to an insert flange that separates a first space within the insert cavity for reception of a first panel from a second space within the insert cavity for reception of a second panel. The drainage configuration may also include a clearance space between a lower boundary of an outermost panel received in the insert cavity and a bottom boundary of the insert cavity, the clearance space providing clearance for a drainage flow of a collected fluid from the weeping holes. The drainage configuration may further include a sloped surface at a bottom boundary of the insert cavity that slopes from a relatively greater elevation at an inner side of the insert cavity to an outer side of the insert cavity to direct a drainage flow to the outer side. The sloped surface may be an integral portion of the bottom rail of the fenestration slab, or may be a structural component inserted and supported at the bottom rail of the fenestration slab.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a rear elevation view of a fenestration according to the present invention.

FIG. 2 shows a cross-sectional view of the fenestration in FIG. 1, as seen at line A-A.

FIG. 3 shows a cross-sectional view of the fenestration in FIG. 1, as seen at line B-B.

FIG. 4 shows a close-up view of a lower region of the fenestration slab in FIG. 1.

FIGS. 5A-5C show examples of interchangeable design panels for reception in the fenestration in FIG. 1, in which: FIG. 5A shows a panel with a horizontal slat design; FIG. 5B shows a panel with a curved rod design; and FIG. 5C shows a panel with a polygonal rod design.

FIGS. 6A-6F show examples of fenestration slabs according to the present invention, in which: FIG. 6A shows a fenestration slab with a single elongated insert cavity; FIG. 6B shows a fenestration slab with a single shortened insert cavity and a separate panel region; FIG. 6C shows a fenestration slab with two elongated insert cavities; FIG. 6D shows two fenestration slabs received within a single fenestration frame; FIG. 6E shows a fenestration slab with a circular shape; and FIG. 6F shows a fenestration slab with an oval shape.

FIG. 7 shows an example of the cross-sectional view in FIG. 2, with the hatch slab received within the insert cavity of the fenestration slab.

FIG. 8 shows an example of the cross-sectional view in FIG. 3, with the hatch slab received within the insert cavity of the fenestration slab.

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially,” as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

The term “fenestration,” as used herein, refers to structures that serve as closures to openings in buildings and other standing structures. Such structures include, though are not limited to, doors and windows. Fenestrations as addressed by the present application include those that may serve as closures to openings in other structures, including closures of openings to building envelopes (e.g., houses and office buildings), as well as closures of openings to free-standing structures (e.g., walls, fences, and gates).

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is described in detail with reference to a fenestration illustrated in the drawings in the form of a door. It will be understood that this is a non-limiting example of a door according to the present invention, and that the present invention is equally applicable to fenestrations of other types, including though not limited to windows.

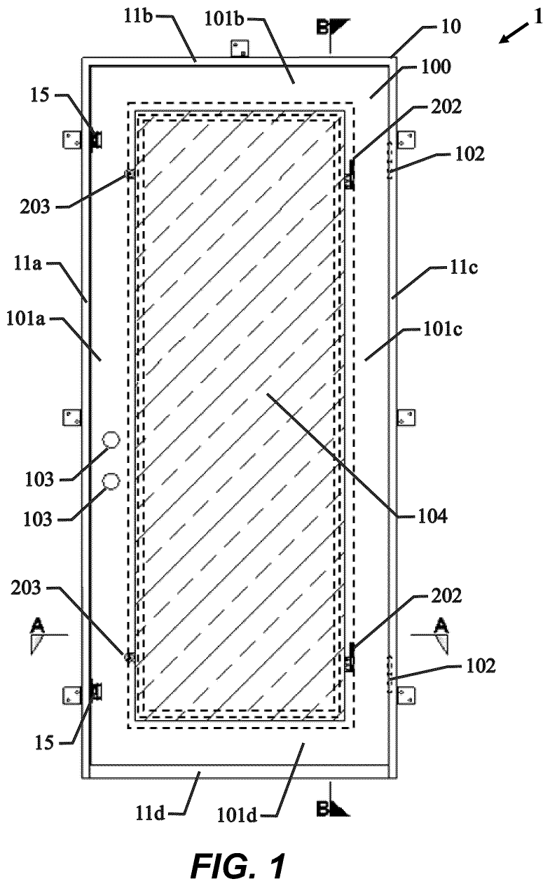

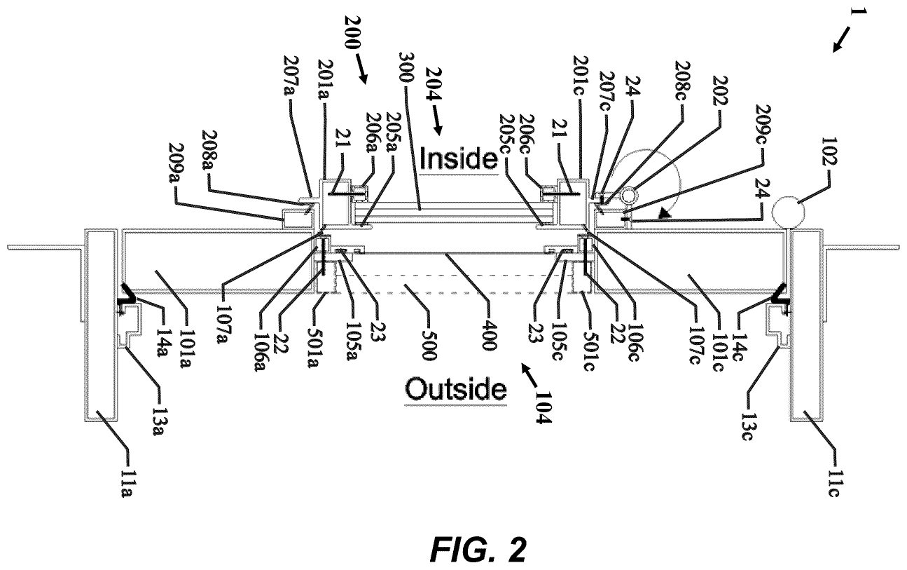

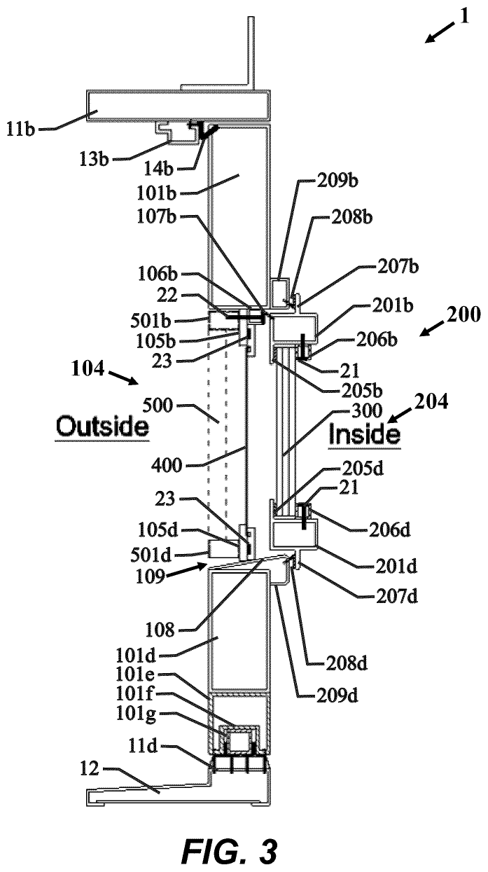

FIG. 1 shows a front elevational view of a fenestration according to the present invention, in the form of a door 1 with a door slab 100 mounted in a door frame 10 as seen from an inner side thereof—e.g., a side intended for positioning within a dwelling upon installation. FIG. 2 shows a cross-sectional view of door 1 as seen along line A-A in FIG. 1, and FIG. 3 shows a cross-sectional view of door 1 as seen along line B-B in FIG. 1. The cross-sectional views are not to scale with the elevational view.

The fenestration slab 100 (door slab 100) has a perimeter 101 defining an outer boundary with an insert cavity 104 at an inner region thereof. In the illustrated example, perimeter 101 is composed of vertical stiles 101a/101c, a top rail 101b and a bottom rail 101d. In other examples, perimeter 101 may have fewer or more individual sides, including though not limited to single-component perimeters (circular shape) and two-component perimeters (two-piece oval shape).

In the illustrated example, the bottom rail 101d includes a sweep-region 101e formed of a galvanized metal with a channel 101f formed in a lower face thereof. A sweep-seal interface beam 101g is inserted into channel 101f and is provided with a weather seal for interfacing with a fenestration frame threshold. The fenestration frame 10 (door frame 10) is provided with vertical jambs 11a/11c, a header 11b and a threshold 11d. In the illustrated example, the threshold 11d is shown with a ramped sill 12. The door slab 100 is pivotably mounted within the door frame 10 via a number of fenestration hinges 102 (door hinges 102) provided at the hinge stile 101c, with lock bores 103 at the lock stile 101a for installation of a locking mechanism. A fenestration shelf 13 (door shelf 13) is provided around a portion of the interior perimeter of the door frame 10, including the vertical jambs 11a/11c and the header 11b, though not along the threshold 11d, and serves as a stopper for positioning the door slab 100 in a closed position. A weather strip 14 is provided along the door shelf 13 to abut the door slab 100, when the door slab 100 is in a closed position, to prevent moisture and air flow through a gap between the door slab 100 and the door frame 10. In the illustrated example, a number of optional fenestration catches 15 (door catches 15) are provided along the lock jamb 11a for further securing the door slab 100 in a closed position. The insert cavity 104 is provided at an interior region of the door slab 100 for reception of one or more slab inserts, such as screen panels 400 and design panels 500.

A hatch slab 200 is pivotably mounted to the inner side of the door slab 100 via a number of hatch hinges 202. The hatch slab 20 is shown in dashed lines in FIG. 1 to permit an unobstructed view of the door slab 100 and insert cavity 104. Vertical stiles 201a/201c of the hatch slab 200 are shown in FIG. 2 and a top rail 201b and a bottom rail 201d of the hatch slab 200 are shown in FIG. 3. A panel cavity 204 is provided at an interior region of the hatch slab 200 for reception of one or more panel inserts 300. Insert panels 300 may also be referred to interchangeably as backing panels 300 and barrier panels 300. The hatch hinges 202 are positioned along the hinge stile 101c of the door slab 100 (FIG. 1) and secured to a hinge stile 201c of the hatch slab 200 (FIG. 2). Panel catches 203 are positioned along lock stile 101a of door slab 100 (FIG. 1) for securing the hatch slab 200 in a closed position. The hatch hinges 202 enable an approximate 180° rotation of the hatch slab 200 from the closed position, barring obstruction by other structures (e.g., door hinges 102).

Panel inserts 300 received in the panel cavity 204 may be any preferred material type, including translucent panels (e.g., glass, plastic, etc.) or opaque panels (e.g., wood, metal, etc.). In the illustrated example, the hatch slab 200 is shown with a double-pane glass panel 300 in the panel cavity 204. The panel insert 300 is secured in the panel cavity 204 between a panel flange 205 and a panel trim 206. The panel flange 205 protrudes from the entire perimeter of the panel cavity 204 toward a central space of the panel cavity 204, and includes vertical flanges 205a/205c, a top flange 205b, and a bottom flange 205d. The panel trim 206 is positioned at a side of the panel insert 300 opposite from the panel flange 205 and likewise extends along the entire perimeter of the panel cavity 204, with vertical trims 206a/206c, a top trim 206b, and a bottom trim 206d. The panel trim 206 may be secured to the hatch slab 200 by a number of mating fasteners 21 in the form of threaded bolts and threaded blind holes.

A hatch shelf 209 provided at the inner side of the door slab 100, along the perimeter of the insert cavity 104, serves as a support and stopper for the hatch slab 200. The hatch shelf 209 includes vertical beams 209a/209c, a top beam 209b and a bottom beam 209d. The hatch hinges 202 are secured at the hinge stile 201c of the hatch slab 200 and the vertical beam 209c of the hatch shelf 209 proximate thereto. In the illustrated example, the hatch hinges 202 are secured to the hatch shelf 209 and the hatch slab 200 via a number of fasteners 24 in the form of threaded bolts and threaded blind holes, though any other suitable fasteners may be used in place thereof. The hatch slab 200 is provided with a hatch trim 207 that protrudes outward from the entire perimeter of the hatch slab 200, with vertical trim 207a/207c, a top trim 207b, and a bottom trim 207d. A weather strip 208 is provided around the entire perimeter of the hatch shelf 209 to abut the hatch trim 207, when the hatch slab 200 is in a closed position, to prevent moisture and air flow through a gap between the hatch slab 200 and the door slab 100. Though not shown in the cross-sectional view of FIG. 2, the panel catches 203 (FIG. 1) are positioned along the vertical beam 209a of the hatch shelf 209 at the opposite side from the hatch hinges 202 to engage the vertical trim 207a of the hatch slab 200.

Within the insert cavity 104 of the door slab 100, an insert flange 105 protrudes inwardly from the entire perimeter of the insert cavity 104, the insert flange 105 including vertical flanges 105a/105c, a top flange 105b, and a bottom flange 105d. An insert shelf 106 extends along portions of the insert flange 105, at an inner side thereof, including along the vertical flanges 105a/105cand the top flange 105b, though not along the bottom flange 105d. The insert shelf 106 and the insert flange 105 are provided with corresponding through-holes for reception of a number of fasteners 22, in the form of threaded bolts, that engage with a corresponding number of mating fasteners, in the form of threaded blind holes, along the frame 501 of a design panel 500 at the opposite outer side of the insert flange 105. A screen panel 400 is secured to the inner side of the insert flange 105 opposite from the outer side where the design panel 500 is secured. In the illustrated example, the insert flange 105 is made of magnetically responsive material and the screen panel 400 is releasably secured to the insert flange 105 by magnetic fasteners 23.

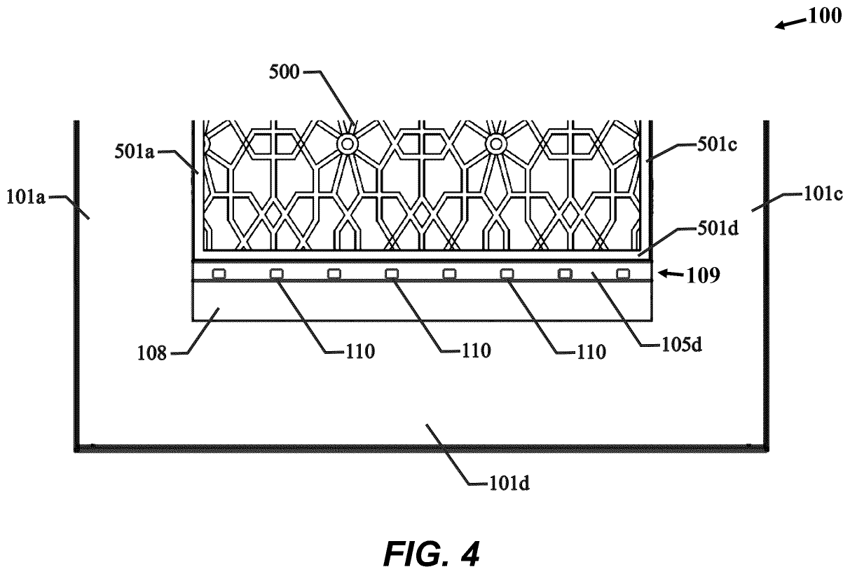

A weather strip 107 is provided along the insert shelf 106 within the insert cavity 104 to abut the hatch slab 200, when the hatch slab 200 is in a closed position, to prevent moisture and air flow through corresponding gaps between the hatch slab 200 and the insert shelf 106. Though the insert flange 105 includes a bottom flange 105d, the insert shelf 106 does not extend along the bottom flange 105d and there are not provided any fasteners along the bottom flange 105d for engaging the frame 501 of the design panel 500, nor is there a weather strip 107 along the bottom flange 105d. The bottom flange 105d is instead provided with a plurality of weeping holes 110 (FIG. 4) and the lower perimeter of the insert cavity 104 is provided with a sloped surface 108 that extends from a relatively greater elevation at an inner side of the insert cavity 104 to a relatively lesser elevation at the outer side of the insert cavity 104. There is also provided a clearance space 109 between the lower border 501d of design frame 501 and the sloped surface 108. FIG. 4 shows a close-up view of the lower region of the door slab 100 with a design panel 500 in insert cavity 104, with weeping holes 110 visible through the clearance space 109 beneath the lower border 501d of design frame 501 and above the sloped surface 108 at the lower perimeter of the insert cavity 104. In the illustrated example, the sloped surface 108 is provided as an integral portion of both the bottom beam 209d of the hatch shelf 209 and the bottom flange 105d of the insert flange 105, though in other examples the sloped surface 108 may be provided as a separate ramp structure secured within the insert cavity 104 or as an integral portion of the insert cavity 104 itself (e.g., a sloped surface along the lower perimeter of the insert cavity, separate from the hatch shelf 209). The configuration of the weeping holes 110, sloped surface 108 and clearance space 109 permits drainage of any moisture that collects within the insert cavity 104, with the drainage directed toward the outer side of the door slab 100.

The illustrated example in the drawings shows mating pairs of fasteners in the form of threaded bolts and threaded blind holes as well as magnetic fasteners and magnetically responsive surfaces, though it will be understood that the fasteners are not limited to these examples and any other suitable fasteners may be used in place thereof. Preference is given to selectively releasable fasteners that permit selective removal, replacement and substitution of the parts secured thereby. In particular, it is preferrable that the fasteners 21 securing the panel trim 206 be selectively releasable such that different panel inserts 300 may be interchangeably installed. Likewise, it is preferrable that the fasteners 22 securing the design frame 501 be selectively releasable such that different design panels 500 may be interchangeably installed. Finally, it is preferrable that the fasteners 23 securing the screen panel 400 be selectively releasable such that the screen panel 400 may be selectively removed and replaced. While panel inserts 300 may themselves be interchangeable via selectively releasable fasteners 21 at panel trim 206, there is an option of selectively interchanging panel inserts 300 by instead selectively interchanging different hatch slabs 200 via the selectively releasable fasteners 24 that secure the hatch slab 200 to hatch hinges 202 and/or hatch shelf 209.

Fenestration slabs 100 according to the present invention provide a multi-layered construction that permits construction of fenestrations 1 from a common template, while permitting customization of individual fenestrations 1 via different combinations of panel inserts 300, screen panels 400, and design panels 500. The layered arrangement of the fenestration slab 100 enables aesthetic customization of a fenestration 1 with a visually appealing design panel 500 arranged at the outer side while a backing panel 300 at an inner side serves as a barrier panel to separate environments on opposite sides of the fenestration 1. Inclusion of the screen panel 400 serves as an intermediate barrier element for use when the panel insert 300 is moved to an open position.

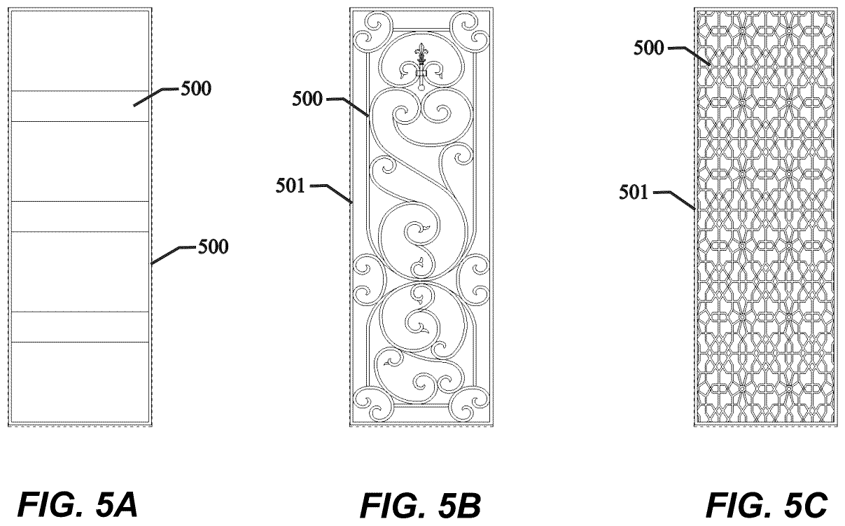

FIGS. 5A-5C show examples of various design panels 500 that may be interchangeably received within the insert cavity 104, including a design with three horizontal slats separating four open spaces (FIG. 5A); an ornately curved rod design (FIG. 5B); and an ornately polygonal rod design (FIG. 5C). The use of releasable fasteners further facilitates interchanging of the various panels such that a user may selectively change the appearance of a fenestration 1 as they choose. Pivotable construction of the hatch slab 200 also permits a user to selectively open the hatch slab 200 to permit an air flow through fenestration 1 while the fenestration slab 100 remains in a securely closed position. The unique construction of fenestrations according to the present invention promotes faster construction of highly customized fenestrations while reducing inventory load.

The selective interchangeability of components also permits a user to alter the configuration of a fenestration as desired, for example, changing out a translucent panel insert 300 for an opaque panel insert 300 when desiring increased privacy, or changing out a first design panel 500 for a second design panel 500 when desiring a change of aesthetic. The selective interchangeability of components also reduces costs for repairs in the event of damage to the fenestration, as a broken panel may simply be removed and replaced without requiring installation of an entirely new fenestration. This also improves resale prospects of a property as a buyer may redesign the appearance of the fenestrations by selectively interchanging the various components, without need to replace the fenestrations as a whole, thereby reducing costs of remodeling the property after purchase.

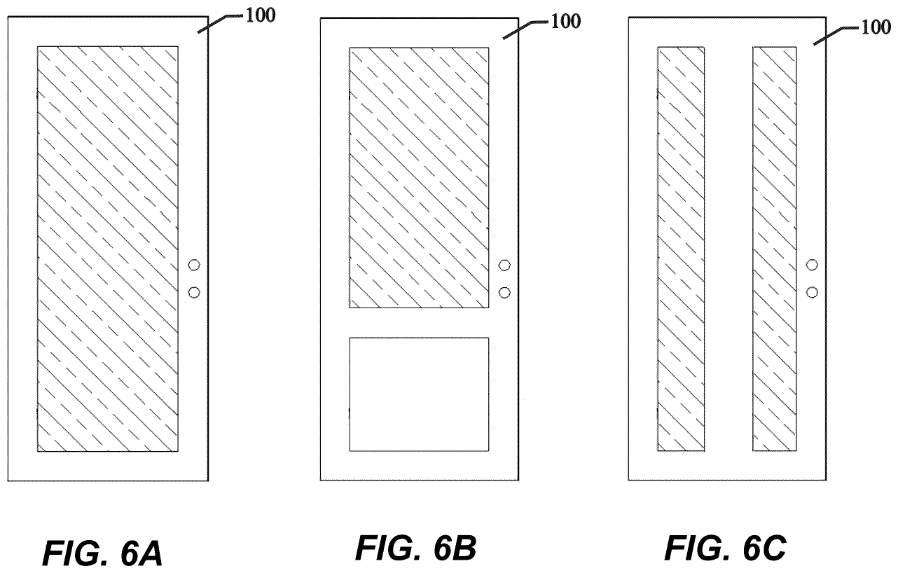

The foregoing discussion addresses a non-limiting example of the invention in which the insert cavity 104 and hatch panel 200 extend over substantially the entirety of the inner surface area of the fenestration slab 100. For example, the fenestration slab 100 may have a height of approximately 96 inches and a width of approximately 42 inches, with the individual stiles 101a/101c and rails 101b/101d that form the outer perimeter of the fenestration slab 100 having widths of approximately 6 inches and depths of approximately 2 inches, such that the insert cavity has a height of approximately 84 inches, a width of approximately 30 inches, and a depth of approximately 2 inches. In such a configuration, the hatch slab 200 would be made with sufficient height and width to correspond with the dimensions of the insert cavity 104 as conveyed by the accompanying figures. FIG. 6A shows an example of such a fenestration slab as seen from an outer side.

Though the foregoing discussion addresses an example in which the insert cavity 104 and hatch slab 200 extend over nearly the entire height of the fenestration slab 100, the invention is not limited to such configurations. For example, the insert cavity 104 and hatch slab 200 may instead extend over only an upper region of the fenestration slab 100 (e.g., upper quarter, upper half, upper three-quarters, etc.) and the remaining lower region may either be left bare or may be provided with some other features such as a kick/push plate or portal (e.g., mail slot, pet door, etc.), with the upper and lower regions in such a configuration optionally separated by one or more cross rails extending horizontally between the hinge stile 101c and the lock stile 101a of the fenestration slab 100. FIG. 6B shows an example of such a fenestration slab as seen from an outer side.

Though the foregoing discussion addresses an example in which there is a single insert cavity 104 and a single corresponding hatch slab 200 extend thereover, the invention is not limited to such configurations. For example, the fenestration slab 100 may be provided with one or more mullions that extend vertically between the top rail 101b and bottom rail 101d of the fenestration slab 100, and/or between one or more horizontal cross rails to thereby define two or more separate insert cavities 104 with a corresponding hatch slab 200 for each separate insert cavity 104. Such configurations would enable further customization of a fenestration 1 and further control over the volume of airflow therethrough. FIG. 6C shows an example of such a fenestration slab as seen from an outer side.

Though the foregoing discussion addresses an example in which a single fenestration slab 100 is present within a single fenestration frame 10, the invention is not limited to such configurations. For example, there may be two or more separate fenestration slabs 100 present within a single fenestration frame, with one or two or more of the multiple fenestration slabs 100 each having a separate hatch slab 200. FIG. 6D shows an example in which two fenestration slabs 100 are adapted for installation in a single fenestration frame 10 in a Dutch door configuration, as seen from an outer side, with the top fenestration slab 100 having a hatch slab 200 and the bottom fenestration slab 100 having a standard panel configuration (without a hatch slab 200). In other similar configurations, each fenestration slab 100 may have a hatch slab 200.

Though the foregoing discussion addresses an example of a fenestration slab 100 in the form of a rectangular door slab 100, the invention is not limited to such configurations. Fenestration slabs according to the present invention may include other fenestration types, including though not limited to windows. Fenestration slabs according to the present invention are also not limited to rectangular shapes and may take any shape including circular and oval shapes such as those illustrated in FIGS. 6E and 6F, respectively. Whereas the rectangular fenestration slab 100 in the example addressed above was discussed relative to rectangular components, such as vertical stiles 101a/101c, top rail 101b and bottom rail 101d, it will be understood that fenestration slabs according to the present invention may instead be discussed with reference to arcuate or other shaped stiles and rails, or simply with reference to a perimeter that may include all of the foregoing stiles and rails or which may substitute for such components, for example, with a single arcuate perimeter rail for an oval or circular shaped fenestration slab.

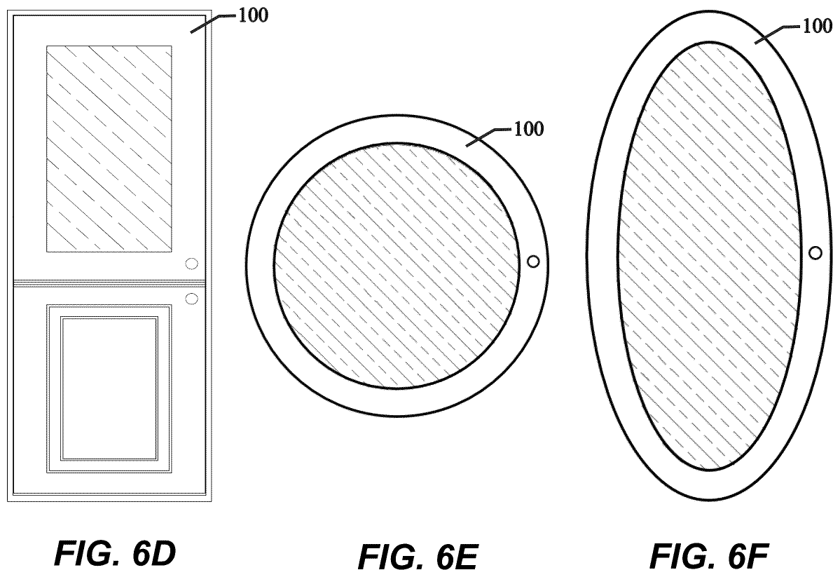

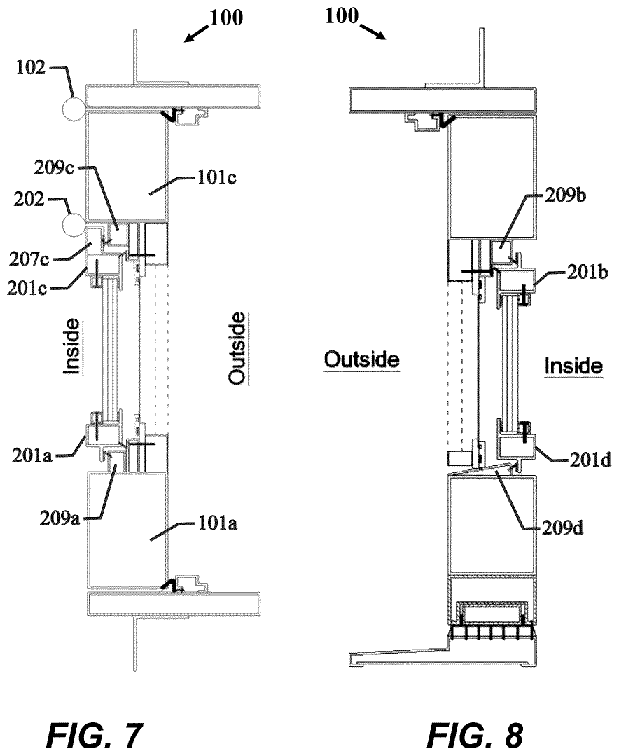

Though the foregoing discussion addresses an example in which the hatch slab 200 protrudes from inner side surfaces of the door slab 100, the invention is not limited to such configurations. For example, the hatch slab 200 may instead be dimensioned for reception within the insert cavity 104 such that when the hatch slab 200 is in a closed position an inner side surface of the hatch slab 200 may rest approximately flush with an inner side surface of the fenestration slab 100. FIGS. 7 and 8 show one non-limiting example of such a configuration, reproducing the same views as seen in FIGS. 2 and 3, though with the slab hatch 200 received within insert cavity 104. FIGS. 7 and 8 are illustrated with limited reference numbers for addressing differences discussed here, and it will be understood that components lacking reference numbers in FIGS. 7 and 9 will be identified by the reference numbers associated with corresponding components in FIGS. 2 and 3. In this example, the modified configuration may be achieved by increasing a relative thickness of the perimeter 101 of the fenestration slab 100; relocating the slab shelf 209 to an interior surface of the insert cavity 104, with a slight change to the shape of the bottom beam 209d thereof; increasing a thickness of the vertical trim 207c; and adapting the hatch hinges 202 to take a form similar to the fenestration hinges 102, with the hatch hinges 202 engaging opposing surfaces of hinge stile 101c and vertical trim 207c.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

1. A fenestration slab comprising:
a perimeter defining an outer boundary of the fenestration slab, with an insert cavity at an inner region of the fenestration slab, the insert cavity being configured to releasably hold one or more interchangeable panels;
a hatch slab supported on the fenestration slab, the hatch slab having an outer perimeter and a panel cavity at an inner region of the hatch slab, the panel cavity being configured to hold one or more panels;
wherein the hatch slab is pivotably supported on the fenestration slab for rotation between a first position and a second position, the first position being a closed position in which the outer perimeter of the hatch slab is positioned to correspond with a perimeter of the insert cavity in the fenestration slab such that the hatch slab serves to close an opening to the insert cavity of the fenestration slab, with the panel cavity of the hatch slab aligning with the insert cavity of the fenestration slab.

2. The fenestration slab according to claim 1, wherein
the hatch slab is mounted at an inner side surface of the fenestration slab such that the perimeter of the hatch slab protrudes from the inner surface of the fenestration slab when in the closed position.

3. The fenestration slab according to claim 1, wherein
the hatch slab is mounted at a surface within the insert cavity of the fenestration slab such that the perimeter of the hatch slab resides within the insert cavity of the fenestration slab when in the closed position.

4. The fenestration slab according claim 1, wherein
a design panel is releasably secured within the insert cavity of the fenestration slab; and a backing panel is releasably secured within the panel cavity of the hatch slab.

5. The fenestration slab according to claim 4, wherein
the design panel is an ornate panel with openings that permit an airflow therethrough.

6. The fenestration slab according to claim 4, wherein
the backing panel is a barrier panel that prevents airflow through the panel cavity.

7. The fenestration slab according to claim 4, wherein
the backing panel is a translucent panel.

8. The fenestration slab according to claim 4, wherein
a screen panel is releasably secured in the insert cavity, at a position to reside between the design panel and the backing panel.

9. The fenestration slab according claim 1, wherein
the fenestration slab comprises weather sealing between the insert cavity and the hatch slab to hinder fluid flow from an outer side of the fenestration slab to an inner side of the fenestration slab through the insert cavity; and
the insert cavity is formed with a drainage configuration that promotes drainage of collected fluid to the outer side of the fenestration slab.

10. The fenestration slab according to claim 9, wherein
the insert cavity comprises an insert flange that separates a first space within the insert cavity for reception of a first panel from a second space within the insert cavity for reception of a second panel, and at least a portion of the insert flange is provided with weeping holes that form a part of the drainage configuration for drainage of collected fluid.

11. The fenestration slab according to claim 9, wherein
the insert cavity is configured to support an outermost panel received therein with a clearance space between a lower boundary of the outermost panel and a bottom boundary of the insert cavity, the clearance space forming a part of the drainage configuration for drainage of collected fluid.

12. The fenestration slab according to claim 9, wherein
the drainage configuration comprises a sloped surface at a bottom boundary of the insert cavity that slopes from a relatively greater elevation at an inner side of the insert cavity to an outer side of the insert cavity.

13. The fenestration slab according to claim 12, wherein
the sloped surface is an integral portion of the bottom rail of the fenestration slab.

14. The fenestration slab according to claim 12, wherein
the sloped surface is a structural component supported at the bottom rail of the fenestration slab.

15. The fenestration slab according to claim 1, wherein
the fenestration slab is configured for use as a door slab.

16. The fenestration slab according to claim 1, wherein
the fenestration slab is configured for use as a window slab.

17. A method of making a fenestration slab according to claim 1, comprising:
securing the hatch slab to the fenestration slab.
